(19) United States
(12) Patent Application Publication
(10) Pub. No.: US 2022/0240505 A1
(43) Pub. Date: Aug. 4, 2022

(54) Herbicidal Mixtures Containing Amine Salts of Acidic Herbicides

(71) Applicant: MONSANTO TECHNOLOGY LLC, Saint Louis, MO (US)

(72) Inventors: Andrew D. DYSZLEWSKI, Saint Louis, MO (US); Alison MACINNES, Wildwood, MO (US)

(21) Appl. No.: 17/625,962

(22) PCT Filed: Jul. 10, 2020
(86) PCT No.: PCT/US2020/041510

§ 371 Date: Jan. 10, 2022

Related U.S. Application Data
(60) Provisional application No. 62/873,026, filed on Jul. 11, 2019.

(51) Int. Cl. A01N 39/04; A01N 25/02; A01N 33/04; A01N 57/20

(52) U.S. Cl. CPC A01N 39/04; A01N 57/20; A01N 33/04; A01N 25/02

(57) ABSTRACT

Herbicidal compositions such as aqueous herbicidal concentrate compositions and application mixtures are described. In particular, the present invention relates to various aqueous herbicidal compositions comprising a combination of acidic herbicides formulated as certain amine salts. The present invention also relates to various processes for preparing and using these herbicidal compositions.

### FIELD OF THE INVENTION

The present invention generally relates to herbicidal compositions such as aqueous herbicidal concentrate compositions and herbicidal application mixtures. In particular, the present invention relates to various aqueous herbicidal compositions comprising a combination of acidic herbicides formulated as certain amine salts. The present invention also relates to various processes for preparing and using these herbicidal compositions.

### BACKGROUND OF THE INVENTION

To enhance the efficiency of applying herbicidal active ingredients, it is highly desirable to combine two or more active ingredients in a single formulation. Applying a combination of active ingredients with different modes of herbicidal action can provide for greater weed control. Also, concentrate compositions containing high loadings of active ingredients are more economical to transport and store. Concentrate compositions containing high loadings of multiple active ingredients (i.e., pre-mix concentrates) are also beneficial in avoiding or reducing mixing errors when preparing application mixtures in the field. However, formulating highly loaded herbicidal concentrate compositions that exhibit sufficient stability can be challenging. Increasing the concentration of herbicidal active ingredients and formulation additives necessarily increases solution density, which can result in formulation instability. Thus, there remains a need for strategies to formulate stable highly loaded concentrates containing multiple herbicidal active ingredients.

Auxin herbicides, such as dicamba and 2,4-D, are particularly effective herbicides suited for supplementing primary herbicides, such a glyphosate, and controlling growth of unwanted plants, including those with selected herbicide resistance. However, volatility is sometimes associated with some auxin herbicides under certain conditions of application. Thus, there remains a need for formulations containing multiple herbicidal actives, including an auxin herbicide, that exhibit acceptable volatility characteristics upon application.

### BRIEF SUMMARY OF THE INVENTION

Various aspects of the present invention relate to aqueous herbicidal compositions comprising:
a first acidic herbicide comprising a first acidic herbicide anion;
a second acidic herbicide comprising a second herbicide anion, wherein the first acidic herbicide and second acidic herbicide are not the same herbicide; and
a salt-forming cation of a diamine of Formula I:

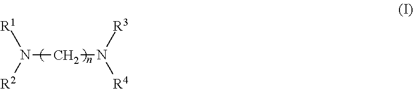

wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6.

Other aspects of the present invention relate to methods of controlling plant growth in a growing area comprising applying an application mixture comprising an herbicidal composition as described herein, or dilution thereof, to foliage of the plant.

Further aspects of the present invention are directed to various process for preparing herbicidal compositions as described herein. One process comprises mixing a first acidic herbicide comprising a first acidic herbicide anion, a second acidic herbicide comprising a second herbicide anion, water, and a diamine of Formula Ito form the composition. Another process comprises mixing a first acidic herbicide comprising a first acidic herbicide anion, water, and a first amount of diamine of Formula Ito form a first acidic herbicide salt solution; mixing a second herbicide comprising a second acidic herbicide anion, water, and a second amount diamine of Formula Ito form a second acidic herbicide salt solution; and mixing the first acidic herbicide salt solution and second acidic herbicide salt solution to form the composition. Still another process comprises mixing a first acidic herbicide salt solution comprising a first acidic herbicide anion and a cation of a diamine of Formula I with a second herbicide comprising a second acidic herbicide anion to form the composition.

Other objects and features will be in part apparent and in part pointed out hereinafter.

### DETAILED DESCRIPTION

The present invention generally relates to herbicidal compositions such as aqueous herbicidal concentrate compositions and herbicidal application mixtures. In particular, the present invention relates to various aqueous herbicidal compositions comprising a combination of acidic herbicides formulated as certain amine salts. The present invention also relates to various processes for preparing and using these herbicidal compositions.

It has been discovered that formulating various acidic herbicides, such as auxin herbicides, with certain amines provides for herbicide salts having improved water solubility. It has also been discovered that the amines used to formulate these herbicide salts can advantageously provide for highly loaded herbicidal concentrates. These amines possess two amine functional groups. Thus, the amount of amine required to fully neutralize one mole of an acidic herbicide (i.e., to fully neutralize one mole of a monoprotic herbicide acid or fully neutralize one acid group of one mole of a polyprotic herbicide acid) is reduced by as much as half as compared to salt-forming compounds having a single amine functional group or a monovalent metal (e.g., sodium). Decreasing the amount of salt-forming compound necessary for neutralization permits higher loadings of herbicidal active(s) in the composition. Further, it has been discovered these amines can be used to prepare highly loaded premixes containing multiple acidic herbicides.

It also been discovered that formulating various auxin herbicides with these amines provides for herbicidal compositions that exhibit reduced auxin herbicide volatility. In addition to having sufficient stability, these compositions can provide for reduced vaporization and migration of the auxin herbicide from the application site to adjacent crop plants where contact damage to sensitive plants can occur.

### I. Herbicidal Compositions

Various embodiments of the present invention are directed an aqueous herbicidal composition comprising: a first acidic herbicide comprising a first acidic herbicide anion; a second acidic herbicide comprising a second herbicide anion, wherein the first acidic herbicide and second acidic herbicide are not the same herbicide; and a salt-forming cation of a diamine of Formula I:

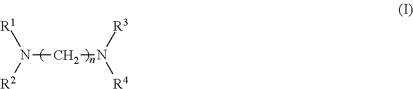

wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6. R² is C₁-C₆ alkyl; R³ is hydrogen; R⁴ is hydrogen, and/or n is 2, 3, 4, 5, or 6.

In various embodiments, R¹ is C₁-C₆ alkyl. In some embodiments, R¹ is methyl, ethyl or propyl. In other embodiments, R¹ is hydrogen.

In various embodiments, R² is C₁-C₆ alkyl. In some embodiments, R² is methyl, ethyl or propyl. In other embodiments, R² is hydrogen.

In various embodiments, R³ is hydrogen. In other embodiments, R³ is C₁-C₆ alkyl (e.g., methyl, ethyl or propyl).

In various embodiments, R⁴ is hydrogen. In other embodiments, R³ is C₁-C₆ alkyl (e.g., methyl, ethyl or propyl).

In various embodiments, n is 2, 3, or 4. In certain embodiments, n is 3. In other embodiments, n is 2.

In various embodiments, the diamine of Formula I is 3-(dimethylamino)-1-propylamine. In some embodiments, the diamine of Formula I is ethylenediamine.

In various embodiments, the composition has a molar ratio of total acidic herbicide to diamine that is about 0.5:1 or greater or about 0.75:1 or greater. For example, the composition can have a molar ratio of total acidic herbicide to diamine that is from about 0.5:1 to about 2:1, from about 0.75:1 to about 2:1, from about 0.5:1 to about 1.8:1, or from about 0.75:1 to about 1.8:1. The total acidic herbicide is the sum of the acidic herbicides present in the composition, such as the sum of the first acidic herbicide and the second acidic herbicide.

In some embodiments, the number of moles of total acidic herbicide can be equivalent to or exceed the number of moles of the diamine. For example, the composition can have a molar ratio of total acidic herbicide to diamine that is about 1:1 or greater. In various embodiments, the composition has a molar ratio of total acidic herbicide to diamine that is from about 1:1 to about 2:1 or from about 1:1 to about 1.8:1.

As noted, the diamine of Formula I possesses two amine functional groups. Each amine functional group of the diamine can react with an acid group of the acidic herbicide. Thus, an equimolar amount of the diamine is not required to neutralize one mole of an acidic herbicide (i.e., fully neutralize one mole of a monoprotic herbicide acid or fully neutralize one acid group of one mole of a polyprotic herbicide acid). Accordingly, in various embodiments, the composition has a molar ratio of the total acidic herbicide to diamine that is about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater. In various embodiments, the composition has a molar ratio of total acidic herbicide to diamine that is from about 1.1:1 to about 2:1, from about 1.2:1 to about 2:1, from about 1.3:1 to about 2:1, from about 1.4:1 to about 2:1, from about 1.5:1 to about 2:1, from about 1.6:1 to about 2:1, from about 1.7:1 to about 2:1, from about 1.1:1 to about 1.8:1, from about 1.2:1 to about 1.8:1, from about 1.3:1 to about 1.8:1, from about 1.4:1 to about 1.8:1, from about 1.5:1 to about 1.8:1, from about 1.6:1 to about 1.8:1, or from about 1.7:1 to about 1.8:1.

Typically, the composition has a pH that is no greater than about 7, no greater than about 6.5, or no greater than about 6. In various embodiments, the composition has a pH that is no greater than about 5.9, no greater than about 5.8, no greater than about 5.7, no greater than about 5.6, no greater than about 5.5, no greater than about 5.4, no greater than about 5.3, or no greater than about 5.25. For example, the composition can have a pH that is from about 4.5 to about 7, from about 4.5 to about 6.5, from about 4.5 to about 6, from about 4.5 to about 5.8, from about 4.5 to about 5.5, from about 4.5 to about 5.3, from about 5 to about 7, from about 5 to about 6.5, from about 5 to about 6, from about 5 to about 5.8, from about 5 to about 5.5, from about 5 to about 5.3, from about 5.2 to about 7, from about 5.2 to about 6.5, from about 5.2 to about 6, from about 5.2 to about 5.8, from about 5.2 to about 5.5, or from about 5.3 to about 5.4.

In various embodiments, the weight ratio of the first acidic herbicide to the second acidic herbicide is from about 10:1 to about 1:10, from about 5:1 to about 1:5, from about 3:1 to about 1:3, from about 2:1 to about 1:2, from about 10:1 to about 1:1, from about 10:1 to about 2:1, from about 10:1 to about 3:1, or from about 10:1 to about 5:1 on an acid equivalent basis.

In various embodiments, the composition is an aqueous herbicidal concentrate composition. Accordingly, the total acidic herbicide concentration in various aqueous herbicidal concentrate compositions of the present invention can be at least about 400 g a.e./L, at least about 450 g a.e./L, at least about 460 g a.e./L, at least about 470 g a.e./L, or at least about 480 g a.e./L. In some embodiments, the total acidic herbicide concentration is from about 400 g a.e./L to about 500 g a.e./L, from about 400 g a.e./L to about 490 g a.e./L, from about 400 g a.e./L to about 480 g a.e./L, from about 450 g a.e./L to about 500 g a.e./L, from about 450 g a.e./L to about 490 g a.e./L, from about 450 g a.e./L to about 480 g a.e./L, from about 460 g a.e./L to about 500 g a.e./L, from about 460 g a.e./L to about 490 g a.e./L, or from about 460 g a.e./L to about 480 g a.e./L.

In other embodiments, the composition is an application mixture (e.g., an aqueous dilution of the abovementioned concentrate composition). Accordingly, the total acidic herbicide concentration in an application mixture of the present invention can be no more than about 5 wt. % or from about 0.1 wt. % to about 5 wt. % on an acid equivalent basis (e.g., about 5 wt. %, about 4 wt. %, about 3 wt. %, about 2 wt. %, about 1 wt. %, about 0.5 wt. %, or about 0.1 wt. % on an acid equivalent basis).

In some embodiments, the concentration of the first acidic herbicide in the composition can be at least about 1 wt. %, at least about 2 wt. %, at least about 5 wt. %, at least about 10 wt. %, at least about 15 wt. %, at least about 20 wt. %, at least about 30 wt. % on an acid equivalent basis. For example, in various embodiments, the concentration of the first acidic herbicide can be from about 0.1 wt. % to about 10 wt. %, from about 0.1 wt. % to about 5 wt. %, from about 0.1 wt. % to about 3 wt. %, from about 0.5 wt. % to about 10 wt. %, from about 0.5 wt. % to about 5 wt. %, or from about 0.5 wt. % to about 3 wt. %. In further embodiments, the concentration of the first acidic herbicide is from about 10 wt. % to about 35 wt.%, from about 15 wt. % to about 35 wt. %, from about 20 wt. % to about 35 wt. %, from about 25 wt. % to about 35 wt. %, from about 30 wt. % to about 35 wt. %, from about 10 wt. % to about 30 wt. %, from about 15 wt. % to about 30 wt. %, from about 20 wt. % to about 30 wt. %, from about 25 wt. % to about 30 wt. %, from about 10 wt. % to about 25 wt. %, from about 15 wt. % to about 25 wt. %, from about 20 wt. % to about 25 wt. %, from about 10 wt. % to about 20 wt. %, or from about 15 wt. % to about 20 wt. % on an acid equivalent basis.

Similarly, in various embodiments, the concentration of the second acidic herbicide in the composition can be at least about 1 wt. %, at least about 2 wt. %, at least about 5 wt. %, at least about 10 wt. %, at least about 15 wt. %, at least about 20 wt. %, at least about 30 wt. % on an acid equivalent basis. In some embodiments, the concentration of the second acidic herbicide is from about 0.1 wt. % to about 10 wt. %, from about 0.1 wt. % to about 5 wt. %, from about 0.1 wt. % to about 3 wt. %, from about 0.5 wt. % to about 10 wt. %, from about 0.5 wt. % to about 5 wt. %, or from about 0.5 wt. % to about 3 wt. %. In further embodiments, the concentration of the second acidic herbicide is from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 10 wt. % to about 30 wt. %, from about 15 wt. % to about 30 wt. %, from about 20 wt. % to about 30 wt. %, from about 25 wt. % to about 30 wt. %, from about 10 wt. % to about 25 wt. %, from about 15 wt. % to about 25 wt. %, from about 20 wt. % to about 25 wt. %, from about 10 wt. % to about 20 wt. %, or from about 15 wt. % to about 20 wt. % on an acid equivalent basis.

The composition can be free or essentially free of other salt-forming cations, excluding those of the diamine of Formula I. For example, the composition can have a molar ratio of total acidic herbicide anion to other salt-forming cations, excluding those of the diamine of Formula I, that is at least about 25:1, at least about 50:1, at least about 100:1, at least about 500:1, or at least about 1000:1. In various embodiments, the composition contains no more than about 5 wt .%, no more than about 1 wt. %, no more than about 0.1 wt. %, no more than about 0.01 wt. %, or no more than about 0.001 wt. % of other salt-forming cations, excluding those of the diamine of Formula I. In these embodiments, the other salt-forming cations can be selected from the group consisting of potassium, sodium, ammonium, isopropylammonium, monoethanolammonium, diethanolammonium, triethanolammonium, dimethylammonium, diglycolammonium, and mixtures thereof.

### Acidic Herbicides

As noted, the composition comprises at least two different acidic herbicides. In various embodiments, the acidic herbicides (first acidic herbicide, second acidic herbicide, and so on) possess at least one carboxylic acid functional group.

One particular class of acidic herbicides includes auxin herbicides. Thus, in various embodiments, the first acidic herbicide and/or second acidic herbicide comprises one or more auxin herbicides. Auxin herbicide include, for example, 3,6-dichloro-2-methoxybenzoic acid (dicamba); 2,4-dichlorophenoxyacetic acid (2,4-D); 4-(2,4-dichlorophenoxy)butyric acid (2,4-DB); dichloroprop; 2-methyl-4-chlorophenoxyacetic acid (MCPA); 4-(4-chloro-2-methylphenoxy)butanoic acid (MCPB); 4-chlorophenoxyacetic acid; 2,4,5-trichlorophenoxyacetic acid (2,4,5-T); aminopyralid; clopyralid; fluroxypyr; triclopyr; mecoprop; picloram; quinclorac; aminocyclopyrachlor; benazolin; halauxifen; fluorpyrauxifen; methyl 4-amino-3-chloro-5-fluoro-6-(7-fluoro-1H-indol-6-yl)pyridine-2-carboxylic acid; 4-amino-3-chloro-5-fluoro-6-(7-fluoro-1H-indol-6- yl)pyridine-2-carboxylic acid; benzyl 4-amino-3-chloro-5-fluoro-6-(7-fluoro-1H-indol-6-yl)pyridine-2-carboxylic acid; methyl 4-amino-3-chloro-5-fluoro-6-(7-fluoro-1-isobutyryl-1H-indol-6-yl)pyridine-2-carboxylic acid; methyl 4-amino-3-chloro-6-[1-(2,2-dimethylpropanoyl)-7-fluoro-1H-indol-6-yl]-5-fluoropyridine-2-carboxylic acid; methyl 4-amino-3-chloro-5-fluoro-6-[7-fluoro-1-(methoxyacetyl)-1H-indol-6-yl]pyridine-2-carboxylic acid; methyl 6-(1-acetyl-7-fluoro-1H-indol-6-yl)-4-amino-3-chloro-5-fluoropyridine-2-carboxylic acid; butyl 4-amino-3-chloro-5-fluoro-6-(7-fluoro-1H-indo1-6-yl)pyridine-2-carboxylic acid; and mixtures thereof.

In some embodiments, the auxin herbicide comprises 2,4-D (i.e., the first or the second acidic herbicide is 2,4-D). In certain embodiments, the auxin herbicide comprises dicamba (i.e., the first or the second acidic herbicide is dicamba).

Other acidic herbicides include various organophosphorus herbicides. Thus, in various embodiments, the first acidic herbicide and/or second acidic herbicide comprises one or more organophosphorus herbicides. In some embodiments, the first acidic herbicide and/or second acidic herbicide comprises one or more organophosphorus herbicides having at least one carboxylic acid functional group. In certain embodiments, the organophosphorus herbicide comprises glyphosate (i.e., the first or the second acidic herbicide is glyphosate).

In further embodiments, the organophosphorus herbicide comprises glufosinate (i.e., the first or the second acidic herbicide is glufosinate). Glufosinate is also referred to as phosphinothricin. Phosphinothricin has two stereoisomers (D- and L-enantiomers). L-phosphinothricin is typically the most efficacious of the stereoisomers. As used herein, the term “glufosinate” encompasses the D-, and L-enantiomers of phosphinothricin and racemic mixtures thereof.

In various embodiments, the first acidic herbicide and second acidic herbicide are each independently selected from the group consisting of auxin herbicides and organophosphorus herbicides. For example, in some embodiments, the first acidic herbicide is an auxin herbicide and the second acidic herbicide is an organophosphorus herbicide. In other embodiments, the first acidic herbicide is an organophosphorus herbicide and the second acidic herbicide is an auxin herbicide. In certain embodiments, the first acidic herbicide and second acidic herbicide are each independently selected from the group consisting of 2,4-D, dicamba, glyphosate, and glufosinate. In particular embodiments, the first acidic herbicide is 2,4-D and the second acidic herbicide is glyphosate.

### Surfactants

The compositions as described herein can further comprise a surfactant component comprising at least one surfactant. In various embodiments, the surfactant component concentration (total surfactant concentration) in the concentrate compositions described herein can be at least about 1 wt. %, at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 12 wt. %, at least about 15 wt. %, or at least about 20 wt. %. For example, the surfactant component concentration can be from about 1 wt. % to about 25 wt. %, from about 2 wt. % to about 25 wt. %, from about 3 wt. % to about 25 wt. %, from about 4 wt. % to about 25 wt. %, from about 5 wt. % to about 25 wt. %, from about 5 wt. % to about 20 wt. %, from about 10 wt. % to about 20 wt. %, from about 15 wt. % to about 20 wt. %, or from about 10 wt. % to about 15 wt. %.

Surfactants generally include various nonionic surfactants, cationic surfactants, anionic surfactants, amphoteric surfactants, and mixtures thereof. Examples of suitable surfactants include, but are not limited to: alkoxylated tertiary amines; alkoxylated tertiary etheramines; alkoxylated quaternary amines; alkoxylated quaternary etheramines; alkyl polysaccharides; amidoalkylamines; alkoxylated alcohols; alkoxylated etheramine oxides; alkoxylated tertiary amine oxides; alkyl sulfates, alkyl ether sulfates and alkyl aryl ether sulfates; alkyl sulfonates, alkyl ether sulfonates and alkyl aryl ether sulfonates; alkoxylated phosphate esters and diesters; and mixtures thereof. Examples of certain surfactants are described below.

### Alkoxylated Tertiary Amine Surfactants

In some embodiments, the surfactant component comprises an alkoxylated alkylamine. Examples of alkoxylated tertiary amine surfactants include compounds of Formula (1):

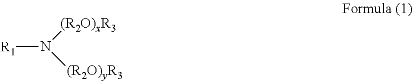

wherein R₁ is a straight or branched chain hydrocarbyl having an average of from about 5 to about 22 carbon atoms, preferably from about 12 to about 18 carbon atoms, more preferably a mixture of straight or branched chain hydrocarbyl groups having from about 14 to about 18 carbon atoms, still more preferably a mixture of straight or branched chain hydrocarbyl groups having from about 16 to about 18 carbon atoms (tallow), each R₂ in each of the (R₂O) groups is C₁-C₄ alkylene, more preferably C₂ alkylene, each R₃ is independently hydrogen or C₁-C₄ alkyl, preferably hydrogen, and, in some embodiments, x and y are average numbers such that the sum of x and y is from about 3 to about 30, more preferably from about 5 to about 20, more preferably from about 8 to about 20, more preferably from 8 to about 15, and still more preferably from about 9 to about 10. In other embodiments, x and y are average numbers such that the sum of x and y is greater than 5, such as in the range of from 6 to about 15, from 6 to about 12, or from 6 to about 10. Examples of suitable surfactants include, without restriction, BEROL 300 (cocoamine 5EO), BEROL 381 (tallowamine 15EO), BEROL 391 (tallowamine 5EO), BEROL 397 (cocoamine 15 EO), BEROL 398 (cocoamine 11 EO), BEROL 498 (tallowamine 10 EO), ETHOMEEN C/15 (cocoamine 5EO), ETHOMEEN C/25 (cocoamine 15 EO), ETHOMEEN T/15 (tallowamine 5EO), ETHOMEEN T/20 (tallowamine 10EO), ETHOMEEN T/19 (tallowamine 9EO), ETHOMEEN T/25 (tallowamine 15 EO), WITCAMINE TAM-105 (tallowamine 10 EO), WITCAMINE TAM-80 (tallowamine 8 EO), WITCAMINE TAM-60 (tallowamine 6EO), all available from Nouryon.

### Alkoxylated Tertiary Etheramine Surfactants

In some embodiments, the surfactant component comprises an alkoxylated tertiary etheramine of Formula (2):

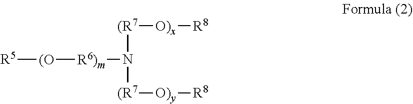

wherein R⁵ is a hydrocarbyl or substituted hydrocarbyl having from about 4 to about 22 carbon atoms; R⁶ and R⁷ are each independently a hydrocarbylene having 2, 3, or 4 carbon atoms; each R⁸ is independently hydrogen or C₁-C₆ alkyl, m is an average number from about 1 to about 10; and the sum of x and y is an average value ranging from about 2 to about 60. R⁵ is preferably an alkyl having an average value ranging from about 4 to about 22 carbon atoms, more preferably from about 8 to about 22 carbon atoms, and still more preferably from about 10 to about 20 carbons atoms, for example coco, tallow, oleyl, and stearyl. Sources of the R⁵ group include, for example, coco or tallow, or R⁵ may be derived from synthetic hydrocarbyls, such as decyl, dodedecyl, tridecyl, tetradecyl, hexadecyl, or octadecyl groups. The number m is preferably from about 1 to 5, such as 2 to 3. R⁶ and R⁷ are preferably independently ethylene, propylene, isopropylene, and are preferably ethylene. R⁸ is preferably hydrogen. The sum of x and y is preferably an average value ranging from about 2 to about 25. One preferred example of an alkoxylated tertiary etheramine surfactant is SURFONIC AGM 550 available from Huntsman Petrochemical Corporation wherein R⁵ is C₁₂₋₁₄, R⁶ is isopropyl, R⁷ is ethylene, R⁸ is hydrogen, m is 2 and the sum of x and y is 5.

### Alkoxylated Quaternary Amine Surfactants

In some embodiments, the surfactant component comprises an alkoxylated quaternary amine surfactant of Formula (3):

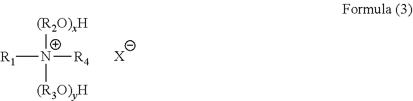

wherein R₁ is a hydrocarbyl or substituted hydrocarbyl having from about 4 to about 22 carbon atoms, R₂ and R₃ are each independently hydrocarbylene having 2, 3, or 4 carbon atoms, and the sum of x and y is an average value ranging from about 2 to about 50. R₄ is preferably a hydrocarbyl or substituted hydrocarbyl having from 1 to about 4 carbon atoms, more preferably methyl. X is a charge balancing counter-anion, such as sulfate, chloride, bromide, nitrate, among others.

R₁ is preferably an alkyl having from about 4 to about 22 carbon atoms, more preferably from about 8 to about 18 carbon atoms, and still more preferably from about 12 to about 18 carbons atoms, for example coco or tallow. R¹ is most preferably tallow. R₂ and R₃ are preferably ethylene. The sum of x and y is preferably an average value ranging from about 2 to about 22, more preferably between about 10 and about 20, for example, about 15.

Specific alkoxylated quaternary amine surfactants for use in the compositions of the present invention include, for example, ETHOQUAD T/12, ETHOQUAD T/20, ETHOQUAD T/25, ETHOQUAD C/12, ETHOQUAD C/15, and ETHOQUAD C/25, each of which are available from Nouryon. One preferred alkoxylated quaternary ammonium surfactant is ETHOQUAD C-12 (a cocoalkylmethylbis(2-hydroxyethyl) ammonium chloride surfactant available from Nouryon). In various embodiments, the surfactant component system may include a solvent or other additives. For example, when ETHOQUAD C/12 is incorporated intoan herbicidal composition, it may be added as a mixture containing diethylene glycol (DEG) or polyethylene glycol (PEG). Therefore, in certain embodiments, the surfactant component comprises ETHOQUAD C/12 dissolved in diethylene glycol or polyethylene glycol (e.g., a mixture containing 75 wt. % ETHOQUAD C/12 and 25 wt. % diethylene glycol or polyethylene glycol).

### Alkoxylated Quaternary Etheramine Surfactants

In some embodiments, the surfactant component comprises an alkoxylated quaternary etheramine surfactant of Formula (4):

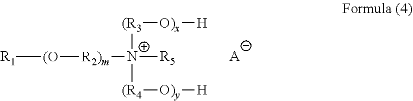

wherein R₁ is a hydrocarbyl or substituted hydrocarbyl having from about 4 to about 22 carbon atoms; R₂, R₃ and R₄ are each independently is a hydrocarbylene having 2, 3, or 4 carbon atoms; m is an average number from about 1 to about 10; and the sum of x and y is an average value ranging from about 2 to about 60. R₅ is preferably a hydrocarbyl or substituted hydrocarbyl having from 1 to about 4 carbon atoms, more preferably methyl. A is a charge balancing counter-anion, such as sulfate, chloride, bromide, nitrate, among others.

R₁ is preferably an alkyl having from about 4 to about 22 carbon atoms, more preferably from about 8 to about 18 carbon atoms, from about 10 to about 16 carbon atoms, from about 12 to about 18 carbons atoms, or from about 12 to about 14 carbon atoms. Sources of the R¹ group include, for example, coco or tallow, or R¹ may be derived from synthetic hydrocarbyls, such as decyl, dodedecyl, tridecyl, tetradecyl, hexadecyl, or octadecyl groups. M is preferably from about 1 to 5, such as 2 to 3. R₂, R₃ and R₄ may independently be ethylene, propylene, isopropylene, and are preferably ethylene. R₅ is preferably methyl. The sum of x and y is preferably an average value ranging from about 2 to about 22, such as from about 2 to 10, or about 2 to 5. In some embodiments, the sum of x and y is preferably between about 10 and about 20, for example, about 15.

### Alkylpolysaccharide Surfactants

In some embodiments, the surfactant component comprises one or more alkylpolysaccharide surfactants. Examples of alkylpolysaccharide surfactants include compounds of Formula (5):

R¹¹—O-(sug)ᵤ Formula (5)

wherein R¹¹ is a straight or branched chain substituted or unsubstituted hydrocarbyl selected from alkyl, alkenyl, alkylphenyl, alkenylphenyl having from about 4 to about 22 carbon atoms for from about 4 to 18 carbon atoms. The sug moiety is a saccharide residue, and may be an open or cyclic (i.e., pyranose) structure. The saccharide may be a monosaccharide having 5 or 6 carbon atoms, a disaccharide, an oligosaccharide or a polysaccharide. Examples of suitable saccharide moieties, including their corresponding pyranose form, include ribose, xylose, arabinose, glucose, galactose, mannose, telose, gulose, allose, altrose, idose, lyxose, ribulose, sorbose (sorbitan), fructose, and mixtures thereof. Examples of suitable disaccharides include maltose, lactose and sucrose. Disaccharides, oligosaccharides and polysaccharides can be a combination of two or more identical saccharides, for example maltose (two glucoses) or two or more different saccharides, for example sucrose (a combination of glucose and fructose). The degree of polymerization, u, is an average number from 1 to about 10, from 1 to about 8, from 1 to about 5, from 1 to about 3, and from 1 to about 2. In various embodiments, the alkylpolysaccharide surfactant may be an alkylpolyglucoside (APG) surfactant of Formula (5) wherein: R¹¹ is a branched or straight chain alkyl group preferably having from 4 to 22 carbon atoms or from 8 to 18 carbon atoms, or a mixture of alkyl groups having an average value within the given range; sug is a glucose residue (e.g., a glucoside); and u is from 1 to about 5, and more preferably from 1 to about 3. In various embodiments, the surfactant component comprises an APG of Formula (5) wherein R¹¹ is a branched or straight chain alkyl group having from 8 to 10 carbon atoms or a mixture of alkyl groups having an average value within the given range and u is from 1 to about 3.

Examples of alkylpolysaccharide surfactant are known in the art. Some preferred alkylpolysaccharide surfactants include AGNIQUE PG8107-G (AGRIMUL PG 2067) available from BASF and AL-2559 (C₉₋₁₁ alkylpolysaccharide) available from Croda. Representative surfactants are also presented in the table below wherein for each surfactant sug is a glucose residue.

Alkylpolysaccharide Surfactants

| Trade name | R¹¹ | u |
|---|---|---|
| APG 225 | C₈₋₁₂ alkyl | 1.7 |
| APG 325 | C₉₋₁₁ alkyl | 1.5 |
| APG 425 | C₈₋₁₆ alkyl | 1.6 |
| APG 625 | C₁₂₋₁₆ alkyl | 1.6 |
| GLUCOPON 600 | C₁₂₋₁₆ alkyl | 1.4 |
| PLANTAREN 600 | C₁₂₋₁₄ alkyl | 1.3 |
| PLANTAREN 1200 | C₁₂₋₁₆ alkyl | 1.4 |
| PLANTAREN 1300 | C₁₂₋₁₆ alkyl | 1.6 |
| PLANTAREN 2000 | C₈₋₁₆ alkyl | 1.4 |
| Agrimul PG 2076 | C₈₋₁₀ alkyl | 1.5 |
| Agrimul PG 2067 | C₈₋₁₀ alkyl | 1.7 |
| Agrimul PG 2072 | C₈₋₁₆ alkyl | 1.6 |
| Agrimul PG 2069 | C₉₋₁₁ alkyl | 1.6 |
| Agrimul PG 2062 | C₁₂₋₁₆ alkyl | 1.4 |
| Agrimul PG 2065 | C₁₂₋₁₆ alkyl | 1.6 |
| BEROL AG6202 | 2-ethyl-1-hexyl | |

### Amidoalkylamine Surfactants

The surfactant component can comprise one or more amidoalkylamine surfactants. Examples of amidoalkylamine surfactants include compounds of Formula (6):

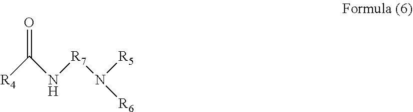

wherein R₄ is a hydrocarbyl or substituted hydrocarbyl having from 1 to about 22 carbon atoms, R₅ and R₆ are each independently hydrocarbyl or substituted hydrocarbyl having from 1 to about 6 carbon atoms and R₇ is hydrocarbylene or substituted hydrocarbylene having from 1 to about 6 carbon atoms.

R₄ is preferably an alkyl or substituted alkyl having an average value of carbon atoms between about 4 to about 20 carbon atoms, preferably an average value between about 4 and about 18 carbon atoms, more preferably an average value from about 4 to about 12 carbon atoms, more preferably an average value from about 5 to about 12 carbon atoms, even more preferably an average value from about 6 to about 12 carbon atoms, and still more preferably an average value from about 6 to about 10 carbon atoms. The R₄ alkyl group may be derived from a variety of sources that provide alkyl groups having from about 4 to about 18 carbon atoms, for example, the source may be butyric acid, valeric acid, caprylic acid, capric acid, coco (comprising mainly lauric acid), myristic acid (from, e.g., palm oil), soy (comprising mainly linoleic acid, oleic acid, and palmitic acid), or tallow (comprising mainly palmitic acid, oleic acid, and stearic acid). In some embodiments, the amidoalkylamine surfactant component may comprise a blend of amidoalkylamines having alkyl chains of various lengths from about 5 carbon atoms to about 12 carbon atoms. For example, depending upon the source of the R₄ alkyl group, an amidoalkylamine surfactant component may comprise a blend of surfactants having R₄ groups that are 5 carbon atoms in length, 6 carbon atoms in length, 7 carbon atoms in length, 8 carbon atoms in length, 9 carbon atoms in length, 10 carbon atoms in length, 11 carbon atoms in length, and 12 carbon atoms in length, longer carbon chains, and combinations thereof. In other embodiments, the amidoalkylamine surfactant component may comprise a blend of surfactants having R₄ groups that are 5 carbon atoms in length, 6 carbon atoms in length, 7 carbon atoms in length, and 8 carbon atoms in length. In some embodiments, the amidoalkylamine surfactant component may comprise a blend of surfactants having R₁ groups that are 6 carbon atoms in length, 7 carbon atoms in length, 8 carbon atoms in length, 9 carbon atoms in length, and 10 carbon atoms in length. In other embodiments, the amidoalkylamine surfactant component may comprise a blend of surfactants having R₄ groups that are 8 carbon atoms in length, 9 carbon atoms in length, 10 carbon atoms in length, 11 carbon atoms in length, and 12 carbon atoms in length.

R₅ and R₆ are independently preferably an alkyl or substituted alkyl having from 1 to about 4 carbon atoms. R₅ and R₆ are most preferably independently an alkyl having from 1 to about 4 carbon atoms, and most preferably methyl. R₇ is preferably an alkylene or substituted alkylene having from 1 to about 4 carbon atoms. R₇ is most preferably an alkylene having from 1 to about 4 carbon atoms, and most preferably n-propylene.

In various amidoalkylamine surfactants, R₄ is C₆₋₁₀, i.e., an alkyl group having 6 carbon atoms, 7 carbon atoms, 8 carbon atoms, 9 carbon atoms, 10 carbon atoms, or a blend of any of these, i.e., from about 6 carbon atoms to about 10 carbon atoms; R₅ and R₆ are each methyl; and R₇ is n-propylene (i.e., C₆₋₁₀ amidopropyl dimethylamine). One preferred amidoalkylamine surfactants is ADSEE C80W (coco amidopropyl dimethylamine), which is available from Nouryon.

### Alkoxylated Alcohol Surfactants

In some embodiments, the surfactant component comprises an alkoxylated alcohol surfactant. Examples of alkoxylated alcohol surfactants include compounds of Formula (7):

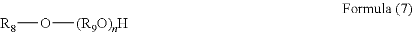

wherein R₈ is a straight or branched chain hydrocarbyl having fan average of from about 4 to about 22 carbon atoms; each R₉ in each of the (R₉O) groups is independently selected from C₁-C₄ alkylene (e.g., n-propylene and/or ethylene); and n is an average value of from about 2 to about 50.

R₈ is preferably an alkyl group having from about 4 to about 22 carbon atoms, more preferably from about 8 to about 18 carbon atoms, and still more preferably from about 12 to about 18 carbons atoms. R₅ may be branched or straight. Preferably, R₈ is straight. The R₈ alkyl group may be derived from a variety of sources that provide alkyl groups having from about 4 to about 22 carbon atoms, for example, the source may be butyric acid, valeric acid, caprylic acid, capric acid, coco (comprising mainly lauric acid), myristic acid (from, e.g., palm oil), soy (comprising mainly linoleic acid, oleic acid, and palmitic acid), or tallow (comprising mainly palmitic acid, oleic acid, and stearic acid). Sources of the R₈ group include, for example, coco or tallow, or R₈ may be derived from synthetic hydrocarbyls, such as decyl, dodedecyl, tridecyl, tetradecyl, hexadecyl, or octadecyl groups. The R₈ alkyl chain in a population of alkoxylated alcohol co-surfactants typically comprises alkyl chains having varying length, for example, from 12 to 16 carbons in length, or from 16 to 18 carbons in length, on average. Most preferably, the R₈ alkyl chain comprises predominantly 12 to 16 carbon atoms. R₉ is preferably ethylene. The value of n is preferably an average between about 2 and about 30, more preferably between about 2 and about 20, even more preferably between about 2 and about 10.

### Sulfate Surfactants

In various embodiments, the surfactant component comprises one or more alkyl sulfates, alkyl ether sulfates, and/or alkyl aryl ether sulfates. Examples of these surfactants include compounds of Formulas (8a), (8b), and (8c):

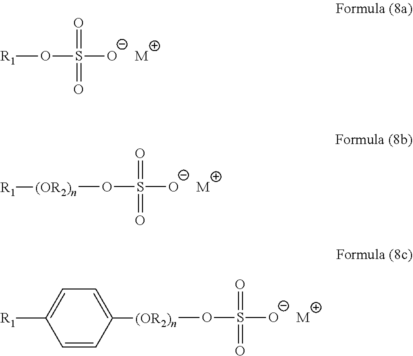

wherein compounds of Formula (8a) are alkyl sulfates, compounds of Formula (8b) are alkyl ether sulfates, and compounds of Formula (8c) are alkyl aryl ether sulfates.

In Formulas (8a), (8b), and (8c), R₁ is a hydrocarbyl or substituted hydrocarbyl having from about 4 to about 22 carbon atoms, and M is selected from an alkali metal cation, ammonium, an ammonium compound, or H⁺. In Formulas (8b) and (8c), each R₂ in each of the (R₂O) groups is independently selected from C₁-C₄ alkylene (e.g., n-propylene and/or ethylene), and n is from 1 to about 20. Examples of alkyl sulfates include sodium C₈₋₁₀ sulfate, sodium C₁₀₋₁₆ sulfate, sodium lauryl sulfate, sodium C₁₄₋₁₆ sulfate, diethanolamine lauryl sulfate, triethanolamine lauryl sulfate and ammonium lauryl sulfate. Examples of alkyl ether sulfates include sodium C₁₂₋₁₅ pareth sulfate (1 EO), ammonium C₆₋₁₀ alcohol ether sulfate, sodium C₆₋₁₀ alcohol ether sulfate, isopropylammonium C₆₋₁₀ alcohol ether sulfate, ammonium C₁₀₋₁₂ alcohol ether sulfate, sodium lauryl ether sulfate. Examples of alkyl aryl ether sulfates include sodium nonylphenol ethoxylate sulfates. Specific examples of sulfate surfactants include AGNIQUE SLES-270 (C₁₀₋₁₆, 1-2.5 EO, sodium lauryl ether sulfate), WITCOLATE 1247H (C₆₋₁₀, 3EO, ammonium sulfate), WITCOLATE 7093 (C₆₋₁₀, 3EO, sodium sulfate), WITCOLATE 7259 (C₈₋₁₀ sodium sulfate), WITCOLATE 1276 (C₁₀₋₁₂, 5EO, ammonium sulfate), WITCOLATE LES-60A (C₁₂₋₁₄, 3EO, ammonium sulfate), WITCOLATE LES-60C (C₁₂₋₁₄, 3EO, sodium sulfate), WITCOLATE 1050 (C₁₂₋₁₅, 10EO, sodium sulfate), WITCOLATE WAQ (C₁₂₋₁₆ sodium sulfate), WITCOLATE D-51-51 (nonylphenol 4EO, sodium sulfate) and WITCOLATE D-51-53 (nonylphenol 10EO, sodium sulfate).

### Sulfonate Surfactants

In various embodiments, the surfactant component comprises one or more alkyl sulfonates, alkyl ether sulfonates, and/or alkyl aryl ether sulfonates. Examples of sulfonate surfactants include compounds of Formulas (9a), (9b), and (9c):

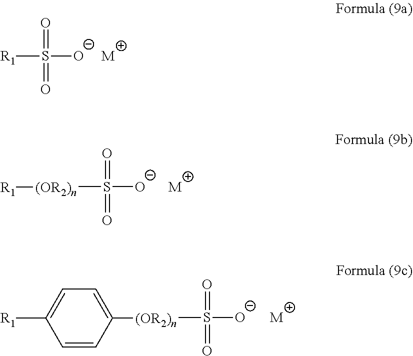

wherein compounds of Formula (9a) are alkyl sulfonates, compounds of Formula (9b) are alkyl ether sulfonates, and compounds of Formula (9c) are alkyl aryl ether sulfonates.

In Formulas (9a), (9b), and (9c), R₁ is a hydrocarbyl or substituted hydrocarbyl having from about 4 to about 22 carbon atoms, and M is selected from an alkali metal cation, ammonium, an ammonium compound, or H⁺. In Formulas (9b), and (9c), each R₂ in each of the (R₂O) groups is independently selected from C₁-C₄ alkylene (e.g., n-propylene and/or ethylene), and n is from 1 to about 20. Examples of sulfonate surfactants include, for example, WITCONATE 93S (isopropylamine of dodecylbenzene sulfonate), WITCONATE NAS-8 (octyl sulfonic acid, sodium salt), WITCONATE AOS (tetradecyl/hexadecyl sulfonic acid, sodium salt), WITCONATE 60T (linear dodecylbenzene sulfonic acid, triethanolamine salt) and WITCONATE 605a (branched dodecylbenzene sulfonic acid, N-butylamine salt).

### Alkoxylated Phosphate Esters Surfactants

In various embodiments, the surfactant component comprises a phosphate ester of an alkoxylated tertiary amine. In some embodiments, the alkoxylated phosphate ester is selected from the group consisting of a phosphate ester of an alkoxylated tertiary amine, phosphate ester of an alkoxylated etheramine, phosphate ester of an alkoxylated alcohol, and a combination thereof. Examples of phosphate esters of alkoxylated tertiary amines include compounds of Formulas (10a) and (10b):

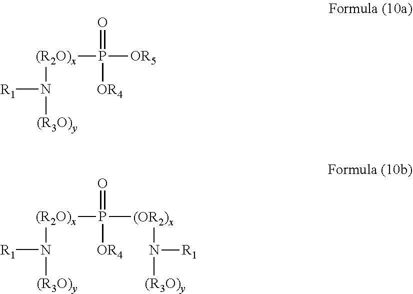

wherein each R₁ is independently a straight or branched chain hydrocarbyl having an average of from about 4 to about 22 carbon atoms, each R₂ in each of the (R₂O) groups and R₃ in each of the (R₃O) groups are each independently selected from C₁-C₄ alkylene, the sum of x and y are average numbers such that the sum of each x and y group is from about 2 to about 60, and R₄ and R₅ are each independently hydrogen or a straight or branched chain hydrocarbyl or substituted hydrocarbyl having from 1 to about 6 carbon atoms.

Each R₁ is preferably independently an alkyl having from about 4 to about 22 carbon atoms, more preferably from about 8 to about 18 carbon atoms, and still more preferably from about 12 to about 18 carbons atoms, for example coco or tallow. R₁ is most preferably tallow. Each R₂ and R₃ is preferably ethylene. The sum of each x and y group is preferably independently an average value ranging from about 2 to about 22, more preferably between about 10 and about 20, for example, about 15. More preferably R₄ and R₅ are each independently hydrogen or a linear or branched chain alkyl having from 1 to about 6 carbon atoms. R₄ and R₅ are preferably hydrogen.

Specific phosphate esters of alkoxylated tertiary amine surfactants are described in U.S. Application Publication No. 2002/0160918, by Lewis et al. (Huntsman Petrochemical Corporation), such as phosphate esters of tallow amine ethoxylates, including phosphate esters of SURFONIC T5, phosphate esters of SURFONIC T15, phosphate esters of SURFONIC T20, and mixtures thereof, all available from Huntsman International LLC.

Examples of phosphate esters of alkoxylated etheramines include compounds of

Formulas (11a) and (11b):

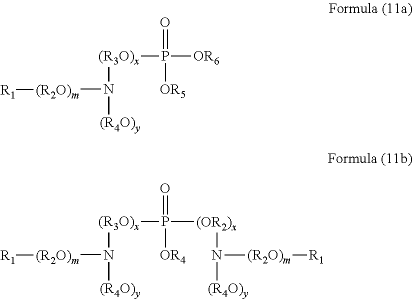

wherein each R₁ is independently a straight or branched chain hydrocarbyl having an average of from about 4 to about 22 carbon atoms; R₂ in each of the (R₂O) groups, R₃ in each of the (R₃O) groups, and R₄ in each of the (R₄O) groups are independently selected from C₁-C₄ alkylene; each m is independently an average number from about 1 to about 10; x and y are average numbers such that the sum of each x and y group is from about 2 to about 60; and each R₅ and R₆ are independently hydrogen or a straight or branched chain alkyl having from 1 to about 6 carbon atoms.

Each R₁ is preferably independently an alkyl having from about 4 to about 22 carbon atoms, more preferably from about 8 to about 18 carbon atoms, from about 10 to about 16 carbon atoms, from about 12 to about 18 carbons atoms, or from about 12 to about 14 carbon atoms. Sources of the R₁ group include, for example, coco or tallow, or R₁ may be derived from synthetic hydrocarbyls, such as decyl, dodedecyl, tridecyl, tetradecyl, hexadecyl, or octadecyl groups. Each R₂ may independently be propylene, isopropylene, or ethylene, and each m is preferably independently from about 1 to 5, such as 2 to 3. Each R₃ and R₄ may independently be ethylene, propylene, isopropylene, and are preferably ethylene. The sum of each x and y group is preferably independently an average value ranging from about 2 to about 22, such as from about 2 to 10, or about 2 to 5. In some embodiments, the sum of each x and y group is preferably independently between about 10 and about 20, for example, about 15. More preferably R₅ and R₆ are each independently hydrogen or a linear or branched chain alkyl having from 1 to about 6 carbon atoms. R₅ and R₆ are preferably hydrogen.

Examples of phosphate esters of alkoxylated alcohols include compounds of

Formulas (12a) and (12b):

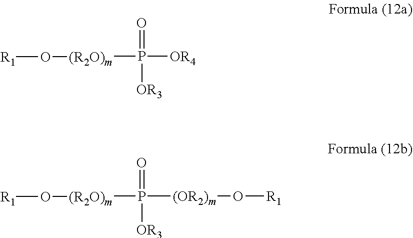

wherein each R₁ is independently a straight or branched chain hydrocarbyl having from about 4 to about 22 carbon atoms; R₂ in each of the (R₂O) groups is independently selected from C₁-C₄ alkylene; each m is independently an average number from about 1 to about 60; and R₃ and R₄ are each independently hydrogen or a straight or branched chain alkyl having from 1 to about 6 carbon atoms.

Each R₁ is preferably independently an alkyl having from about 4 to about 22 carbon atoms, more preferably from about 8 to about 20 carbon atoms, or an alkylphenyl having from about 4 to about 22 carbon atoms, more preferably from about 8 to about 20 carbon atoms. Sources of the R₁ group include, for example, coco or tallow, or R₁ may be derived from synthetic hydrocarbyls, such as decyl, dodedecyl, tridecyl, tetradecyl, hexadecyl, or octadecyl groups. Each R₂ may independently be propylene, isopropylene, or ethylene, and is preferably ethylene. Each m is preferably independently from about 9 to about 15. More preferably R₃ and R₄ are each independently hydrogen or a linear or branched chain alkyl having from 1 to about 6 carbon atoms. R₄ and R₅ are preferably hydrogen.

Specific phosphate esters of alkoxylated alcohol surfactants for use in the herbicidal composition of the present invention include, for example, EMPHOS CS-121, EMPHOS PS-400, and WITCONATE D-51-29, available from Nouryon.

### Additional Herbicidal Ingredients

The herbicidal compositions of the present invention can further comprise one or more additional herbicides (i.e., in addition to the acidic herbicides). For example, application mixtures described herein can contain one or more additional herbicides. As noted, application mixtures can be prepared by diluting aqueous herbicidal concentrate compositions as described herein. Additional herbicides can be “tank mixed” with the application mixtures prepared from the aqueous herbicidal concentrate compositions described herein.

Additional herbicides include acetyl CoA carboxylase (ACCase) inhibitors, enolpyruvyl shikimate-3-phosphate synthase (EPSPS) inhibitors, photosystem I (PS I) inhibitors, photosystem II (PS II) inhibitors, acetolactate synthase (ALS) or acetohydroxy acid synthase (AHAS) inhibitors, mitosis inhibitors, protoporphyrinogen oxidase (PPO) inhibitors, hydroxyphenylpyruvate dioxygenase (HPPD) inhibitors, cellulose inhibitors, oxidative phosphorylation uncouplers, dihydropteroate synthase inhibitors, fatty acid and lipid biosynthesis inhibitors, auxin transport inhibitors, salts and esters thereof, racemic mixtures and resolved isomers thereof, and mixtures thereof. Examples of herbicides within these classes are provided below. Where an herbicide is referenced generically herein by name, unless otherwise restricted, that herbicide includes all commercially available forms known in the art such as salts, esters, free acids and free bases, as well as stereoisomers thereof

In some embodiments, the additional herbicide comprises a PPO inhibitor. PPO inhibitors include, for example, acifluorfen, azafenidin, bifenox, butafenacil, carfentrazone-ethyl, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil and sulfentrazone, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, salts and esters thereof, and mixtures thereof.

In various embodiments, the additional herbicide comprises a HPPD inhibitor. HPPD inhibitors include, for example, aclonifen, amitrole, beflubutamid, benzofenap, clomazone, diflufenican, fluridone, flurochloridone, flurtamone, isoxachlortole, isoxaflutole, mesotrione, norflurazon, picolinafen, pyrazolynate, pyrazoxyfen, sulcotrione, tembotrione, topramezone, tolpyralate, tefuryltrione, salts and esters thereof, and mixtures thereof

In some embodiments, the additional herbicide comprises a PS II inhibitor. PS II inhibitors include, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, salts and esters thereof, and mixtures thereof.

In certain embodiments, the additional herbicide comprises an ACCase inhibitor. ACCase inhibitors include, for example, alloxydim, butroxydim, clethodim, cycloxydim, pinoxaden, sethoxydim, tepraloxydim and tralkoxydim, salts and esters thereof, and mixtures thereof Another group of ACCase inhibitors include chlorazifop, clodinafop, clofop, cyhalofop, diclofop, diclofop-methyl, fenoxaprop, fenthiaprop, fluazifop, haloxyfop, isoxapyrifop, metamifop, propaquizafop, quizalofop and trifop, salts and esters thereof, and mixtures thereof. ACCase inhibitors also include mixtures of one or more “dims” and one or more “fops”, salts and esters thereof.

In various embodiments, the additional herbicide comprises an ALS or AHAS inhibitor. ALS and AHAS inhibitors include, for example, amidosulfuron, azimsulfruon, bensulfuron-methyl, bispyribac-sodium, chlorimuron-ethyl, chlorsulfuron, cinosulfuron, cloransulam-methyl, cyclosulfamuron, diclosulam, ethametsulfuron-methyl, ethoxysulfuron, flazasulfuron, florazulam, flucarbazone, flucetosulfuron, flumetsulam, flupyrsulfuron-methyl, foramsulfuron, halosulfuron-methyl, imazamethabenz, imazamox, imazapic, imazapyr, imazaquin, imazethapyr, imazosulfuron, iodosulfuron, metsulfuron-methyl, nicosulfuron, penoxsulam, primisulfuron-methyl, propoxycarbazone-sodium, prosulfuron, pyrazosulfuron-ethyl, pyribenzoxim, pyrithiobac, rimsulfuron, sulfometuron-methyl, sulfosulfuron, thiencarbazone, thifensulfuron-methyl, triasulfuron, tribenuron-methyl, trifloxysulfuron and triflusulfuron-methyl, salts and esters thereof, and mixtures thereof.

In further embodiments, the additional herbicide comprises a mitosis inhibitor. Mitosis inhibitors include anilofos, benefin, DCPA, dithiopyr, ethalfluralin, flufenacet, mefenacet, oryzalin, pendimethalin, thiazopyr and trifluralin, salts and esters thereof, and mixtures thereof.

In some embodiments, the additional herbicide comprises a PS I inhibitor such as diquat and paraquat, salts and esters thereof, and mixtures thereof.

In certain embodiments, the additional herbicide comprises a cellulose inhibitor such as dichlobenil and isoxaben.

In still further embodiments, the additional herbicide comprises an oxidative phosphorylation uncoupler such as dinoterb, and esters thereof.

In other embodiments, the additional herbicide comprises an auxin transport inhibitor such as diflufenzopyr and naptalam, salts and esters thereof, and mixtures thereof.

In various embodiments, the additional herbicide comprises a dihydropteroate synthase inhibitor such as asulam and salts thereof.

In some embodiments, the additional herbicide comprises a fatty acid and lipid biosynthesis inhibitor such as bensulide, butylate, cycloate, EPTC, esprocarb, molinate, pebulate, prosulfocarb, thiobencarb, triallate and vernolate, salts and esters thereof, and mixtures thereof.

### Other Additives

The herbicidal compositions described herein can further comprise a volatility control additive to control or reduce potential herbicide volatility (e.g., auxin herbicide volatility). For example, as described in U.S. Application Publication Nos. 2014/0128264 and 2015/0264924, which are incorporated herein by reference, additives to control or reduce potential herbicide volatility include various monocarboxylic acids, or salts thereof (e.g., acetic acid and/or an agriculturally acceptable salt thereof). In various embodiments, monocarboxylate salts have the formula R¹—C(O)0M, wherein R¹ is substituted or unsubstituted C₁-C₂₀ alkyl, substituted or unsubstituted C₂-C₂₀ alkenyl, substituted or unsubstituted aryl, and substituted or unsubstituted arylalkyl and M is an agriculturally acceptable cation. Representative monocarboxylic acids and monocarboxylates generally comprise a hydrocarbon or unsubstituted hydrocarbon selected from, for example, unsubstituted or substituted, straight or branched chain alkyl (e.g., C₁-C₂₀ alkyl such as methyl, ethyl, n-propyl, isopropyl, etc.); unsubstituted or substituted, straight or branched chain alkenyl (e.g., C₂-C₂₀ alkyl such as ethenyl, n-propenyl, isopropenyl, etc.); unsubstituted or substituted aryl (e.g., phenyl, hydroxyphenyl, etc.); or unsubstituted or substituted arylalkyl (e.g., benzyl). In particular, the monocarboxylic acid can be selected from the group consisting of formic acid, acetic acid, propionic acid, and benzoic acid. The monocarboxylate salt can be selected from the group consisting of formate salts, acetate salts, propionate salts, and benzoate salts. The monocarboxylate salts can include, for example, alkali metal salts selected from sodium and potassium (e.g., sodium acetate, sodium formate, potassium acetate, and potassium formate).

In some embodiments, the monocarboxylic acid and/or salt thereof comprises formic acid and/or salt thereof. In certain embodiments, the volatility control additive comprises an alkali metal salt thereof (e.g., sodium and potassium salts).

When an auxin herbicide is present, the acid equivalent molar ratio of the volatility control additive to the auxin herbicide can be at least about 1:10, at least about 1:5, at least about 1:3, at least about 1:2, at least about 1:1, at least about 2:1, at least about 3:1, at least about 4:1, at least about 5:1, at least about 6:1, at least about 8:1, or at least about 10:1. For example, the volatility control additive to the auxin herbicide component can be from about 10:1 to about 1:10, from about 10:1 to about 1:5, from about 5:1 to about 1:5, from about 3:1 to about 1:3, from about 2:1 to about 1:2, from about 1:1 to about 10:1, from about 1:1 to about 8:1, from about 1:1 to about 6:1, from about 1:1 to about 5:1, from about 1:1 to about 4:1, from about 1:1 to about 3:1, or from about 1:1 to about 2:1.

In various herbicidal concentrate compositions as described herein, the concentration of the volatility control additive can be at least about 3 wt. %, at least about 5 wt. %, at least about 10 wt. %, at least about 12.5 wt. %, or at least about 15 wt. % on acid equivalent basis. For example, the concentration of the volatility control additive can be from about 3 wt. % to about 30 wt. %, from about 3 wt. % to about 25 wt. %, from about 3 wt. % to about 20 wt. %, from about 4 wt. % to about 20 wt. %, from about 5 wt. % to about 20 wt. %, from about 7 wt. % to about 20 wt. %, from about 8 wt. % to about 20 wt. %, from about 9 wt. % to about 20 wt. %, from about 10 wt. % to about 20 wt. %, or from about 10 wt. % to about 15 wt. % on acid equivalent basis.

The herbicidal compositions described herein can further include other additives. Other useful additives include, for example, biocides or preservatives (e.g., PROXEL, commercially available from Avecia), antifreeze agents (such as glycerol, sorbitol, or urea), antifoam agents (such as Antifoam SE23 from Wacker Silicones Corp.), and drift control agents.

Drift reducing agents (DRA) can also be included in the herbicidal compositions. Examples of drift reducing agents and include GARDIAN, GARDIAN PLUS, DRI-GARD, and PRO-ONE XL, available from Van Diest Supply Co.; COMPADRE, available from Loveland Products, Inc.; BRONC MAX EDT, BRONC PLUS DRY EDT, EDT CONCENTRATE, and IN-PLACE, available from Wilbur-Ellis Company; STRIKE ZONE DF, available from Helena Chemical Co.; INTACT and INTACT XTRA, available from Precision Laboratories, LLC; and AGRHO DR 2000 and AGRHO DEP 775, available from the Solvay Group. Suitable drift reducing agents include, for example, guar-based (e.g., containing guar gum or derivatized guar gum) drift reducing agents. Various drift reducing products may also contain one or more conditioning agents in combination with the drift control agent(s).

### II. Methods of Application

As noted, other aspects of the present invention are directed to methods of controlling the plant growth. Accordingly, various methods of controlling plant growth in a growing area comprise applying an application mixture comprising an herbicidal composition as described herein, or dilution thereof, to foliage of the plant. In various embodiments, the growing area is in and/or adjacent to a field of crop plants. In other embodiments, the growing area is in a greenhouse or a plant container (i.e., a pot or a planter).

In various embodiments, the application mixture is used to control weeds in a field of crop plants. Commercially important crop plants include, for example, corn, soybean, cotton, dry beans, snap beans, potatoes, among others. Crop plants include hybrids, inbreds, and transgenic or genetically modified plants having specific traits or combinations of traits including, without limitation, herbicide tolerance (e.g., resistance to glyphosate, glufosinate, dicamba, sethoxydim, PPO inhibitor, etc.), Bacillus thuringiensis (Bt), high oil, high lysine, high starch, nutritional density, and drought resistance. In some embodiments, the crop plants are tolerant to organophosphorus herbicides, acetolactate synthase (ALS) or acetohydroxy acid synthase (AHAS) inhibitor herbicides, auxin herbicides and/or acetyl CoA carboxylase (ACCase) inhibitor herbicides, In some embodiments, the crop plants are tolerant to glufosinate, dicamba, 2,4-D, MCPA, quizalofop, glyphosate and/or diclofop-methyl. In other embodiments, the crop plant is glufosinate and/or dicamba tolerant. In some embodiments, crop plants are glyphosate and/or glufosinate tolerant. In further embodiments, the crop plants are glyphosate, glufosinate 2,4-D, and dicamba tolerant. In these and other embodiments, the crop plants are tolerant to PPO inhibitors.

The application mixture may be applied to the growing area according to practices known to those skilled in the art. In some embodiments, the application mixture is applied to the growing area post-emergence to unwanted plants or weeds. The herbicidally effective amount of the application mixture to be applied is dependent upon various factors including the identity of the herbicides, the crop to be treated, and environmental conditions such as soil type and moisture content.

Application mixtures of the present invention are useful for controlling a wide variety of weeds, i.e., plants that are considered to be a nuisance or a competitor of commercially important crop plants. Examples of weeds that may be controlled according to methods of the present invention include, but are not limited to, Meadow Foxtail (Alopecurus pratensis) and other weed species with the Alopecurus genus, Common Barnyard Grass (Echinochloa crus-galli) and other weed species within the Echinochloa genus, crabgrasses within the genus Digitaria, White Clover (Trifolium repens), Lambsquarters (Chenopodium berlandieri), Redroot Pigweed (Amaranthus retroflexus) and other weed species within the Amaranthus genus, Common Purslane (Portulaca oleracea) and other weed species in the Portulaca genus, Chenopodium album and other Chenopodium spp., Setaria lutescens and other Setaria spp., Solanum nigrum and other Solanum spp., Lolium multiflorum and other Lolium spp., Brachiaria platyphylla and other Brachiaria spp., Sorghum halepense and other Sorghum spp., Conyza Canadensis and other Conyza spp., and Eleusine indica. In some embodiments, the weeds comprise one or more glyphosate-resistant species, 2,4-D-resistant species, dicamba-resistant species and/or ALS inhibitor herbicide-resistant species. In some embodiments, the glyphosate-resistant weed species is selected from the group consisting of Amaranthus palmeri, Amaranthus rudis, Ambrosia artemisiifolia, Ambrosia trifida, Conyza bonariensis, Conyza canadensis, Digitaria insularis, Echinochloa colona, Eleusine indica, Euphorbia heterophylla, Lolium multiflorum, Lolium rigidum, Plantago lancelata, Sorghum halepense, and Urochloa panicoides.

### III. Processes for Preparing Herbicidal Compositions

The present invention is also directed to various processes for preparing the herbicidal compositions described herein. Generally, the processes involve forming the herbicide salt(s) by mixing the acid form of the herbicide(s) with a diamine of Formula I. A mixture of the salts of the first acidic herbicide and the second acidic herbicide can be prepared by a number of different processes.

One process for preparing a herbicidal composition as described herein comprises mixing a first acidic herbicide comprising a first acidic herbicide anion, a second acidic herbicide comprising a second herbicide anion, water, and a diamine of Formula I to form the composition. In this process, the molar ratio of total acidic herbicide to the diamine of Formula I can be about 0.5:1 or greater, about 0.75:1 or greater, about 1:1 or greater, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater. In various embodiments, the molar ratio of total acidic herbicide to the diamine of Formula I is from about 0.5:1 to about 2:1, from about 0.75:1 to about 2:1, from about 1:1 to about 2:1, from about 1.1:1 to about 2:1, from about 1.2:1 to about 2:1, from about 1.3:1 to about 2:1, from about 1.4:1 to about 2:1, from about 1.5:1 to about 2:1, from about 1.6:1 to about 2:1, from about 1.7:1 to about 2:1, from about 0.5:1 to about 1.8:1, from about 0.75:1 to about 1.8:1, from about 1:1 to about 1.8:1, from about 1.1:1 to about 1.8:1, from about 1.2:1 to about 1.8:1, from about 1.3:1 to about 1.8:1, from about 1.4:1 to about 1.8:1, from about 1.5:1 to about 1.8:1, from about 1.6:1 to about 1.8:1, or from about 1.7:1 to about 1.8:1.

Another process for preparing a herbicidal composition as described herein comprises mixing a first acidic herbicide comprising a first acidic herbicide anion, water, and a first amount of diamine of Formula Ito form a first acidic herbicide salt solution; mixing a second herbicide comprising a second acidic herbicide anion, water, and a second amount diamine of Formula Ito form a second acidic herbicide salt solution; and mixing the first acidic herbicide salt solution and second acidic herbicide salt solution to form the composition. In this process, the molar ratio of total acidic herbicide to the total amount of diamine of Formula I (i.e., sum of first and second amounts) can be about 0.5:1 or greater, about 0.75:1 or greater, about 1:1 or greater, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater. In some embodiments, the molar ratio of total acidic herbicide to the total amount of diamine of Formula I is from about 0.5:1 to about 2:1, from about 0.75:1 to about 2:1, from about 1:1 to about 2:1, from about 1.1:1 to about 2:1, from about 1.2:1 to about 2:1, from about 1.3:1 to about 2:1, from about 1.4:1 to about 2:1, from about 1.5:1 to about 2:1, from about 1.6:1 to about 2:1, from about 1.7:1 to about 2:1, from about 0.5:1 to about 1.8:1, from about 0.75:1 to about 1.8:1, from about 1:1 to about 1.8:1, from about 1.1:1 to about 1.8:1, from about 1.2:1 to about 1.8:1, from about 1.3:1 to about 1.8:1, from about 1.4:1 to about 1.8:1, from about 1.5:1 to about 1.8:1, from about 1.6:1 to about 1.8:1, or from about 1.7:1 to about 1.8:1.

Still another process for preparing a herbicidal composition as described herein comprises mixing a first acidic herbicide salt solution comprising a first acidic herbicide anion and a cation of a diamine of Formula I with a second herbicide comprising a second acidic herbicide anion to form the composition. In this process, the molar ratio of total acidic herbicide to the diamine of Formula I can be about 0.5:1 or greater, about 0.75:1 or greater, about 1:1 or greater, about 1.1:1 or greater, about 1.2:1 or greater, about 1.3:1 or greater, about 1.4:1 or greater, about 1.5:1 or greater, about 1.6:1 or greater, about 1.7:1 or greater, about 1.8:1 or greater, about 1.9:1 or greater, or about 2:1 or greater. In some embodiments, the molar ratio of total acidic herbicide to the diamine of Formula I is from about 0.5:1 to about 2:1, from about 0.75:1 to about 2:1, from about 1:1 to about 2:1, from about 1.1:1 to about 2:1, from about 1.2:1 to about 2:1, from about 1.3:1 to about 2:1, from about 1.4:1 to about 2:1, from about 1.5:1 to about 2:1, from about 1.6:1 to about 2:1, from about 1.7:1 to about 2:1, from about 0.5:1 to about 1.8:1, from about 0.75:1 to about 1.8:1, from about 1:1 to about 1.8:1, from about 1.1:1 to about 1.8:1, from about 1.2:1 to about 1.8:1, from about 1.3:1 to about 1.8:1, from about 1.4:1 to about 1.8:1, from about 1.5:1 to about 1.8:1, from about 1.6:1 to about 1.8:1, or from about 1.7:1 to about 1.8:1.

### DEFINITIONS

As used herein, the term “acid equivalent”, “a.e.”, or “ae” refers to the amount of herbicide present without taking into account the weight of the counter-ion of the salt species if present.

The term “hydrocarbyl” as used herein describes organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

The term “hydrocarbylene” as used herein describes radicals joined at two ends thereof to other radicals in an organic compound, and which consist exclusively of the elements carbon and hydrogen. These moieties include alkylene, alkenylene, alkynylene, and arylene moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

The term “substituted hydrocarbyl” as used herein describes hydrocarbyl moieties that are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

The “substituted hydrocarbylene” moieties described herein are hydrocarbylene moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

Unless otherwise indicated, the alkyl groups described herein are preferably lower alkyl containing from one to 18 carbon atoms in the principal chain and up to 30 carbon atoms. They may be straight or branched chain or cyclic and include methyl, ethyl, propyl, isopropyl, n-butyl, isobutyl, hexyl, 2-ethylhexyl, and the like.

Unless otherwise indicated, the alkenyl groups described herein are preferably lower alkenyl containing from two to 18 carbon atoms in the principal chain and up to 30 carbon atoms. They may be straight or branched chain or cyclic and include ethenyl, propenyl, isopropenyl, butenyl, isobutenyl, hexenyl, and the like. Unless otherwise indicated, the alkynyl groups described herein are preferably lower alkynyl containing from two to 18 carbon atoms in the principal chain and up to 30 carbon atoms. They may be straight or branched chain and include ethynyl, propynyl, butynyl, isobutynyl, hexynyl, and the like. The term “aryl” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

As used herein, the alkyl, alkenyl, alkynyl and aryl groups can be substituted with at least one atom other than carbon, including moieties in which a carbon chain atom is substituted with a hetero atom such as nitrogen, oxygen, silicon, phosphorous, boron, sulfur, or a halogen atom. These substituents include hydroxy, nitro, amino, amido, nitro, cyano, sulfoxide, thiol, thioester, thioether, ester and ether, or any other substituent which can increase the compatibility of the surfactant and/or its efficacy enhancement in the potassium glyphosate formulation without adversely affecting the storage stability of the formulation.

The terms “halogen” or “halo” as used herein alone or as part of another group refer to chlorine, bromine, fluorine, and iodine. Fluorine substituents are often preferred in surfactant compounds.

Unless otherwise indicated, the term “hydroxyalkyl” includes alkyl groups substituted with at least one hydroxy group, e.g., bis(hydroxyalkyl)alkyl, tris(hydroxyalkyl)alkyl and poly(hydroxyalkyl)alkyl groups. Preferred hydroxyalkyl groups include hydroxymethyl (—CH₂OH), and hydroxyethyl (—C₂H₄OH), bis(hydroxy-methyl)methyl (—CH(CH₂OH)₂), and tris(hydroxymethyl)methyl (—C(CH₂OH)₃).

The term “cyclic” as used herein alone or as part of another group denotes a group having at least one closed ring, and includes alicyclic, aromatic (arene) and heterocyclic groups.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heterocyclo include heteroaromatics such as furyl, thienyl, pyridyl, oxazolyl, pyrrolyl, indolyl, quinolinyl, or isoquinolinyl and the like, and non-aromatic heterocyclics such as tetrahydrofuryl, tetrahydrothienyl, piperidinyl, pyrrolidino, etc. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, thioester, thioether, ketal, acetal, ester and ether.

The term “heteroaromatic” as used herein alone or as part of another group denote optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, thioether, thioester, ketal, acetal, ester and ether.

The term “acyl,” as used herein alone or as part of another group, denotes the moiety formed by removal of the hydroxyl group from the group -COOH of an organic carboxylic acid, e.g., RC(O)-, wherein R is R¹, R¹O-, R¹R²N-, or R¹S-, R¹ is hydrocarbyl, heterosubstituted hydrocarbyl, or heterocyclo and R² is hydrogen, hydrocarbyl or substituted hydrocarbyl.

The term “acyloxy,” as used herein alone or as part of another group, denotes an acyl group as described above bonded through an oxygen linkage (—O-), e.g., RC(O)O- wherein R is as defined in connection with the term “acyl.”

When a maximum or minimum “average number” is recited herein with reference to a structural feature such as oxyethylene units, it will be understood by those skilled in the art that the integer number of such units in individual molecules in a surfactant preparation typically varies over a range that can include integer numbers greater than the maximum or smaller than the minimum “average number”. The presence in a composition of individual surfactant molecules having an integer number of such units outside the stated range in “average number” does not remove the composition from the scope of the present invention, so long as the “average number” is within the stated range and other requirements are met.

Having described the invention in detail, it will be apparent that modifications and variations are possible without departing from the scope of the invention defined in the appended claims.

### EXAMPLES

The following non-limiting examples are provided to further illustrate the present invention.

### Example 1

A series of solutions of certain amine salts of 2,4-D were prepared by adding the amine (ethylenediamine or 3-(dimethylamino)-1-propylamine (DMAPA)) to water followed by the addition of 2,4-D acid with stirring unit dissolved to obtain Formulations 10047643-1, 10047643-2, 10047643-3. Tables A1-A3 provide the compositional details for each formulation.

TABLE A1
Formulation 10047643-1

| | | Wt. % | Calculated | Actual |
|---|---|---|---|---|
| Ingredient | Wt. % | active | grams | grams |
| 2,4-D tech (TCI, 97% a.e.) | 42.3% | 41.0% | 84.5 | |
| Ethylenediamine, Acros | 5.8% | | 11.5 | 11.5 |
| Water | 52.0% | | 104.0 | 104.1 |
| Total | 100.0% | | 200.0 | |

Molar ratio of 2,4-D:ethylenediamine = 1:1

TABLE A2
Formulation 10047643-2

| | | Wt. % | Calculated | Actual |
|---|---|---|---|---|
| Ingredient | Wt. % | active | grams | grams |
| 2,4-D tech (TCI, 97% a.e.) | 40.6% | 39.4% | 81.2 | 81.4 |
| 3-(dimethylamino)-1- | 9.4% | | 18.8 | 18.9 |
| propylamine | | | | |
| Water | 50.0% | | 100.0 | 100.1 |
| Total | 100.0% | | 200.0 | |

pH = 7.18, Molar ratio of 2,4-D:DMAPA = 2:1
Loading: 3.9 lbs/gal a.e., 465 g/l a.e.

TABLE A3
Formulation 10047643-3

| | | Wt. % | Calculated | Actual |
|---|---|---|---|---|
| Ingredient | Wt. % | active | grams | grams |
| 2,4-D tech (TCI, 97% a.e.) | 41.8% | 40.5% | 83.5 | 83.8 |
| 3-(dimethylamino)-1- | 9.7% | | 19.3 | 19.4 |
| propylamine | | | | |
| Water | 48.6% | | 97.2 | 97.3 |
| Total | 100.0% | | 200.0 | |

pH = 7.00, Molar ratio of 2,4-D:DMAPA = 2:1
Loading: 4.0 lbs/gal a.e., 481 g/l a.e.

### Example 2

The formulation in Table B1 was prepared as follows. DMAPA was added to an Erlenmeyer flask and stirred. To it was added 6 grams of glyphosate wet cake while stirring, followed by addition of 10 grams of water and temperature was increased to 55° C. To the stirring solution was further added 75 grams of glyphosate wet cake. The resulting solution became thick and was heated to 85° C. for 10 mins. Then was added 10 grams of water and the solution was heated to 98° C. This followed addition of more glyphosate wet cake for a total of 112 grams and the solution was further stirred at 95° C. for 15 mins. To the resulting unclear solution was added remaining water for a total 54.8 grams which was heated at 100° C. After 10 mins. a clear yellow solution was obtained which was allowed to cool and poured through 50 mesh and stored in a glass bottle. Using similar procedures, various formulations were prepared with target loading of 606 g/l a.e., 620 g/l a.e., 607 g/l a.e., and 584 g/l a.e. Table B2 provides the compositional details for the formulation with a target loading of 607 g/l a.e.

TABLE B1
Formulation 10029119

| | | Wt. % | Calculated | Actual |
|---|---|---|---|---|
| Ingredient | Wt. % | active | grams | grams |
| DMAPA | 16.6 | 100.00% | 33.24 | 33.2 |
| water | 27.3 | 100.00% | 54.76 | 54.8 |
| Glyphosate Acid wet cake | 56.0 | 89.30% | 112.00 | 112.1 |
| Total | 100.0 | | 200.00 | 200.10 |

pH = 4.2, Molar ratio of glyphosate:DMAPA = 2:1
Loading: 80.2 wt. % a.i., 50 wt. % a.e., 668 g/l a.e.

TABLE B2
Formulation 10028920

| | | Wt. % | Calculated | Actual |
|---|---|---|---|---|
| Ingredient | Wt. % | active | grams | grams |
| DMAPA | 16.23% | 100.00% | 32.46 | 32.9 |
| water | 31.59% | 100.00% | 63.18 | 63.17 |
| Glyphosate Acid wet cake | 52.18% | 89.30% | 104.36 | 104.5 |
| Total | 100.0 | | 200.00 | 200.57 |

pH = 4.5, Molar ratio of glyphosate:DMAPA = 2:1
Loading: 74.7 wt. % a.i., 46.6 wt. % a.e., 607 g/l a.e.

### Example 3

A series of premixes of 2,4-D DMAPA and glyphosate DMAPA salts were prepared as follows. DMAPA was added to water followed by 2,4-D with stirring until dissolved. Glyphosate wet cake was then added with stirring continuing until dissolution. Then ETHOQUAD C12 75 DEG was added and the solution was stirred for a half hour. Tables B3-B5 provide the compositional details for each formulation. Furthermore, Tables B6-B8 provide similarly prepared formulations, additionally containing oil-based Drift Reducing or Retarding Agents (DRA).

TABLE B3
Formulation 10048811-1

| | | Wt. % | Calculated | Actual |
|---|---|---|---|---|
| Ingredient | Wt. % | active | grams | grams |
| 2,4-D tech (TCI, 97% a.e.) | 20.6% | 20.0% | 41.2 | 41.4 |
| Glyphosate wetcake (96.4%) | 20.7% | 20.0% | 41.5 | 41.6 |
| ETHOQUAD C12 75DEG | 4.0% | | 8.0 | 8.0 |
| 3-(dimethylamino)-1- | 12.8% | | 25.6 | 25.6 |
| propylamine | | | | |
| Water | 41.9% | | 83.7 | 83.7 |
| Total | 100.0% | | 200.0 | |

pH = 5.2, Molar ratio of 2,4-D + Glyphosate:DMAPA = 1.7:1
Loading: 4.0 lbs/gal a.e., 486 g/l a.e.
Weight ratio of 2,4-D:Glyphosate = 1:1

TABLE B4
Formulation 10048811-2

| | | Wt. % | Calculated | Actual |
|---|---|---|---|---|
| Ingredient | Wt. % | active | grams | grams |
| 2,4-D tech (TCI, 97% a.e.) | 20.4% | 19.8% | 40.8 | 41.1 |
| Glyphosate wetcake (96.4%) | 20.5% | 19.8% | 41.1 | 41.2 |
| ETHOQUAD C12 75DEG | 4.0% | | 8.0 | 8.0 |
| 3-(dimethylamino)-1- | 12.7% | | 25.3 | 25.3 |
| propylamine | | | | |
| Water | 42.4% | | 84.8 | 84.9 |
| Total | 100.0% | | 200.0 | |

pH = 5.2, Molar ratio of 2,4-D + Glyphosate:DMAPA = 1.7:1
Loading: 4.0 lbs/gal a.e., 480 g/l a.e.
Weight ratio of 2,4-D:Glyphosate = 1:1

TABLE B5
Formulation 10048811-3

| | | Wt. % | Calculated | Actual |
|---|---|---|---|---|
| Ingredient | Wt. % | active | grams | grams |
| 2,4-D tech (TCI, 97% a.e.) | 17.5% | 17.0% | 35.1 | 35.2 |
| Glyphosate wetcake (96.4%) | 23.7% | 22.8% | 47.3 | 47.4 |
| ETHOQUAD C12 75DEG | 4.0% | | 8.0 | 8.0 |
| 3-(dimethylamino)-1- | 13.2% | | 26.5 | 26.5 |
| propylamine | | | | |
| Water | 41.6% | | 83.2 | 83.2 |
| Total | 100.0% | | 200.0 | |

pH = 5.2, Molar ratio of 2,4-D + Glyphosate:DMAPA = 1.6:1
Loading: 4.0 lbs/gal a.e., 484 g/l a.e.
Weight ratio of 2,4-D:Glyphosate = 0.74:1

TABLE B6
Formulation 10070605-4

| | | Wt. % | Calculated | Actual |
|---|---|---|---|---|
| Ingredient | Wt. % | Active | Kg | Kg |
| 2,4-D Tech (98.2%) | 15.8% | 15.6% | 16.31 | 16.4 |
| glyphosate wetcake (97.73%) | 23.73% | 23.19% | 24.44 | 24.4 |
| 3-(dimethylamino)-1- | 13.08% | | 13.47 | 13.5 |
| propylamine | | | | |
| Oil-based DRA | 3.00% | | 3.09 | 3.0 |
| Crodafos O5A | 3.90% | | 4.02 | 4.0 |
| APG 264 | 2.50% | | 2.58 | 2.6 |
| water | 38.0% | | 39.10 | 39.4 |
| Total | 100.0% | | 103.0 | 103.3 |

pH = 5.03
Loading: 3.9 lbs/gal a.e., 470 g/l a.e.

TABLE B7
Formulation 10070605 -5

| | | Wt % | Calculated | Actual |
|---|---|---|---|---|
| Ingredient | Wt % | Active | Kg | Kg |
| 2,4-D Tech (98.2%) | 15.8% | 15.6% | 15.84 | 15.9 |
| glyphosate wetcake (97.73%) | 23.73% | 23.19% | 23.73 | 23.8 |
| 3-(dimethylamino)-1- | 13.08% | | 13.08 | 13.1 |
| propylamine | | | | |
| Oil-based DRA | 3.00% | | 3.00 | 3.0 |
| Crodafos O5A | 3.90% | | 3.90 | 3.9 |
| APG 264 | 2.50% | | 2.50 | 2.5 |
| Ethoquad C12 | 2.00% | | 2.00 | 2.0 |
| water | 36.0% | | 35.96 | 36.0 |
| Total | 100.0% | | 100.0 | 100.3 |

pH = 4.99
Loading: 3.9 lbs/gal a.e., 471 g/l a.e.

TABLE B8
Formulation 10070605-6

| | | Wt. % | Calculated | Actual |
|---|---|---|---|---|
| Ingredient | Wt. % | Active | Kg | Kg |
| 2,4-D Tech (98.2%) | 13.5% | 13.3% | 13.54 | 13.6 |
| glyphosate wetcake (97.73%) | 20.46% | 20.00% | 20.46 | 20.6 |
| 3-(dimethylamino)-1- | 11.22% | | 11.22 | 11.3 |
| propylamine | | | | |
| Oil-based DRA | 2.50% | | 2.50 | 2.5 |
| Crodafos O5A | 3.00% | | 3.00 | 3.0 |
| APG 264 | 2.00% | | 2.00 | 2.0 |
| Agnique PG 8107 | 4.00% | | 4.00 | 4.1 |
| AGM 550 | 2.00% | | 2.00 | 2.0 |
| water | 41.3% | | 41.27 | 41.3 |
| Total | 100.0% | | 100.0 | 100.4 |

pH = 5.11
Loading: 3.3 lbs/gal a.e., 397 g/l a.e.

### Example 4

The efficacy of 2,4-D standalone formulations and 2,4-D +glyphosate premix formulations was evaluated on velvetleaf (ABUTH) and goosegrass (ELEIN) and compared to ENLIST DUO (premix concentrate of 2,4-D choline salt and glyphosate dimethylammonium salt). Formulations are provided in Table C1. Velvetleaf and goosegrass were sprayed at 4-6″ plant height using a track sprayer with a TTI10015 nozzle calibrated for 15 GPA and percent visual control was recorded at 21 DAT. Overall, the experimental formulations provided excellent control of velvetleaf and goosegrass as shown in Table C2.

TABLE C1
Formulations tested for post-emergent weed efficacy

| | Active 1 | Active 2 | Surfactant |
|---|---|---|---|
| Formulation | (wt. % a.e.) | (wt. % a.e.) | (wt. %) |
| 10048811-2 | Glyphosate | 2,4-D | ETHOQUAD |
| | DMAPA | DMAPA | C12 75DEG |
| | (19.8%) | (19.8%) | (4%) |
| 10049021-1 | Glyphosate | 2,4-D | AGM 550 |
| | DMAPA | DMAPA | (4%) |
| | (19.8%) | (19.8%) | |
| 10049021-2 | Glyphosate | 2,4-D | C-6122 Coco |
| | DMAPA | DMAPA | 2EO quaternary |
| | (19.8%) | (19.8%) | amine and branched |
| | | | PEG 7 C12-15 |
| | | | alcohol blend |
| | | | (4%) |
| 10049021-3 | Glyphosate | 2,4-D | C-6178 Alkylamine |
| | DMAPA | DMAPA | ethoxylate and |
| | (19.8%) | (19.8%) | alkylphosphate |
| | | | ester blend |
| | | | (4%) |

TABLE C2
Post-emergent weed efficacy results in ABUTH and ELEIN

| | | Formula- | | | |
|---|---|---|---|---|---|
| | | tion Con- | | % | % |
| | | centration | Applica- | CONTROL | CONTROL |
| | | (wt. % | tion Rate | (ABUTH) | (ELEIN) |
| No. | Formulation | a.e.) | (g a.e./ha) | 21 DAT | 21 DAT |
| 1 | ENLIST | 16.47 | 420 | 85.0 | 80.0 |
| | DUO | | | | |
| 2 | ENLIST | 16.47 | 840 | 96.7 | 91.3 |
| | DUO | | | | |
| 3 | 10048811-2 | 19.8 | 560 | 95.0 | 87.5 |
| 4 | 10048811-2 | 19.8 | 1120 | 99.0 | 99.2 |
| 5 | 10049021-1 | 19.8 | 560 | 95.5 | 89.2 |
| 6 | 10049021-1 | 19.8 | 1120 | 98.2 | 99.3 |
| 7 | 10049021-2 | 19.8 | 560 | 94.2 | 88.0 |
| 8 | 10049021-2 | 19.8 | 1120 | 97.7 | 100.0 |
| 9 | 10049021-3 | 19.8 | 560 | 95.5 | 90.0 |
| 10 | 10049021-3 | 19.8 | 1120 | 99.7 | 99.7 |

### Example 5

Selected compositions prepared were diluted with water to a 2,4-D concentration of 1.8 wt. % (acid equivalent). The diluted compositions were subjected to a volatility testing by the procedure described in “A Method to Determine the Relative Volatility of Auxin Herbicide Formulations” in ASTM publication STP1587 entitled “Pesticide Formulation and Delivery Systems: 35th Volume, Pesticide Formulations, Adjuvants, and Spray Characterization in 2014, published 2016, which is incorporated herein by reference. The general procedure is described briefly below.

Humidomes obtained from Hummert International (Part Nos 14-3850-2 for humidomes and 11-3050-1 for 1020 flat tray) were modified by cutting a 2.2 cm diameter hole on one end approximately 5 cm from the top to allow for insertion of a glass air sampling tube (22 mm OD) containing a polyurethane foam (PUF) filter. The sampling tube was secured with a VITON o-ring on each side of the humidome wall. The air sampling tube external to the humidome was fitted with tubing that was connected to a vacuum manifold immediately prior to sampling. The flat tray beneath the humidome was filled with 1 liter of sifted dry or wet 50/50 soil (50% Redi-Earth and 50% US 10 Field Soil) to a depth of about 1 cm. A track sprayer was used to apply the compositions at a 2,4-D application rate of 1.5 lb/A a.e. at 10 gallons per acre (GPA) onto the soil of each humidome.

The flat tray bottom containing the auxin herbicide formulation on soil was covered with the humidome lid and the lid was secured with clamps. The growth chambers were set at 35° C. and 40% relative humidity (RH). The assembled humidomes were placed in a temperature and humidity controlled environment and connected to a vacuum manifold through the air sampling line. Air was drawn through the humidome and PUF at a rate of 2 liters per minute (LPM) for 24 hours at which point the air sampling was stopped. The humidomes were then removed from the controlled environment and the PUF filter was removed. The PUF filter was extracted with 20 mL of methanol and the solution was analyzed for the auxin herbicide concentration using LC-MS methods known in the art.

The results of the volatility tests are shown in Table D1-D3 below.

TABLE D1
Humidome Test Results

| Formulation | pH | 2,4-D (ng/L), avg. |
|---|---|---|
| ENLIST DUO | 5.56 | 0.218 |
| 2,4-D amine | 6.60 | 0.313 |
| 2,4-D- DMAPA | 6.81 | 0.010 |
| 10049021-3 | 5.03 | 0.080 |
| 10049021-2 | 4.87 | 0.118 |
| 10048811-2 | 5.16 | 0.070 |

TABLE D2
Humidome Test Results

| Formulation | pH | 2,4-D (ng/L), avg. |
|---|---|---|
| ENLIST DUO | 5.49 | 0.211 |
| 10070605-4 | 4.83 | 0.052 |
| 10070605-5 | 4.89 | 0.070 |
| 10070605-6 | 4.90 | 0.048 |

TABLE D3
Humidome Test Results

| Formulation | pH | 2,4-D (ng/L), avg. |
|---|---|---|
| ENLIST DUO | 5.51 | 0.215 |
| ENLIST ONE | 5.84 | 0.003 |
| 10070605-4 | 4.97 | 0.054 |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions, products, processes, and methods without departing from the scope of the invention, it is intended that all matter contained in the above description shall be interpreted as illustrative and not in a limiting sense.

What is claimed is:

1. An aqueous herbicidal composition comprising:
a first acidic herbicide comprising a first acidic herbicide anion;
a second acidic herbicide comprising a second herbicide anion, wherein the first acidic herbicide and second acidic herbicide are not the same herbicide; and
a salt-forming cation of a diamine of Formula I: 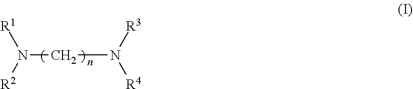
wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6.

2. The composition of claim 1, wherein the number of moles of total acidic herbicide is equivalent to or exceeds the number of moles of the diamine.

3. The composition of claim 1, wherein the composition has a molar ratio of total acidic herbicide to diamine that is about 0.5:1 or greater.

4. The composition of claim 1, wherein the composition has a molar ratio of total acidic herbicide to diamine that is from about 0.5:1 to about 2:1.

5. The composition of claim 1, wherein the composition has a pH that is no greater than about 7.

6. The composition of claim 1, wherein the composition has a pH that is from about 4.5 to about 7.

7. The composition of claim 1, wherein the composition is free or essentially free of other salt-forming cations, excluding those of the diamine of Formula I.

8. The composition of claim 1, wherein the composition has a molar ratio of total acidic herbicide anion to other salt-forming cations, excluding those of the diamine of Formula I, that is at least about 25:1.

9. The composition of claim 1, wherein the composition contains no more than about 5 wt. % of other salt-forming cations, excluding those of the diamine of Formula I.

10. The composition of claim 7, wherein the other salt-forming cations are selected from the group consisting of potassium, sodium, ammonium, isopropylammonium, monoethanolammonium, diethanolammonium, triethanolammonium, dimethylammonium, diglycolammonium, and mixtures thereof.

11. The composition of claim 1, wherein the weight ratio of the first acidic herbicide to the second acidic herbicide is from about 10:1 to about 1:10 on an acid equivalent basis.

12. The composition of claim 1, wherein R¹ is C₁-C₆ alkyl; R² is C₁-C₆ alkyl; R³ is hydrogen; R⁴ is hydrogen, and/or n is 2, 3, 4, 5, or 6.

13. The composition of claim 1, wherein R¹ is methyl, ethyl or propyl; R² is methyl, ethyl or propyl; R³ is hydrogen; R⁴ is hydrogen, and/or n is 2, 3, or 4.

14. The composition of claim 1, wherein the diamine of Formula I is 3-(dimethylamino)-1-propylamine.

15. The composition of claim 1, wherein first acidic herbicide and/or second acidic herbicide possess at least one carboxylic acid functional group.

16. The composition of claim 1, wherein the first acidic herbicide and/or second acidic herbicide comprises one or more auxin herbicides.

17. The composition of claim 16, wherein the auxin herbicide is selected from the group consisting of 3,6-dichloro-2-methoxybenzoic acid (dicamba); 2,4-dichlorophenoxyacetic acid (2,4-D); 4-(2,4-dichlorophenoxy)butyric acid (2,4-DB); dichloroprop; 2-methyl-4-chlorophenoxyacetic acid (MCPA); 4-(4-chloro-2-methylphenoxy)butanoic acid (MCPB); 4-chlorophenoxyacetic acid; 2,4,5-trichlorophenoxyacetic acid (2,4,5-T); aminopyralid; clopyralid; fluroxypyr; triclopyr; mecoprop; picloram; quinclorac; aminocyclopyrachlor; benazolin; halauxifen; fluorpyrauxifen; methyl 4-amino-3-chloro-5-fluoro-6-(7-fluoro-1H-indo1-6-yl)pyridine-2-carboxylic acid; 4-amino-3-chloro-5-fluoro-6-(7-fluoro-1H-indo1-6-yl)pyridine-2-carboxylic acid; benzyl 4-amino-3-chloro-5-fluoro-6-(7-fluoro-1H-indol-6-yl)pyridine-2-carboxylic acid; methyl 4-amino-3-chloro-5-fluoro-6-(7-fluoro-1-isobutyryl-1H-indol-6-yl)pyridine-2-carboxylic acid; methyl 4-amino-3-chloro-6-[1-(2,2-dimethylpropanoyl)-7-fluoro-1H-indol-6-yl]-5-fluoropyridine-2-carboxylic acid; methyl 4-amino-3-chloro-5-fluoro-6-[7-fluoro-1-(methoxyacetyl)-1H-indol-6-yl]pyridine-2-carboxylic acid; methyl 6-(1-acetyl-7-fluoro-1H-indol-6-yl)-4-amino-3-chloro-5-fluoropyridine-2-carboxylic acid; butyl 4-amino-3-chloro-5-fluoro-6-(7-fluoro-1H-indol-6-yl)pyridine-2-carboxylic acid; and mixtures thereof.

18. The composition of claim 16, wherein the auxin herbicide comprises 2,4-D.

19. The composition of claim 16, wherein the auxin herbicide comprises dicamba.

20. The composition of claim 1, wherein the first acidic herbicide and/or second acidic herbicide comprises one or more organophosphorus herbicides.

21. The composition of claim 1, wherein the first acidic herbicide and/or second acidic herbicide comprises one or more organophosphorus herbicides having at least one carboxylic acid functional group.

22. The composition of claim 21, wherein the organophosphorus herbicide comprises glyphosate; and/or
wherein the organophosphorus herbicide comprises glufosinate.

23. (canceled)

24. The composition of claim 1, wherein the first acidic herbicide is 2,4-D and the second acidic herbicide is glyphosate.

25. The composition of claim 1, wherein the total acidic herbicide concentration is at least about 400 g a.e./L.

26. The composition of claim 1, wherein the total acidic herbicide concentration is from about 400 g a.e./L to about 500 g a.e./L.

27. The composition of claim 1, wherein the concentration of the first acidic herbicide is at least about 1 wt.% on an acid equivalent basis.

28. The composition of claim 1, wherein the concentration of the first acidic herbicide is from about 0.1 wt. % to about 35 wt. %, from about 20 wt. % to about 35 wt. %, from about 25 wt. % to about 35 wt. % on an acid equivalent basis.

29. The composition of claim 1, wherein the concentration of the second acidic herbicide is at least about 1 wt. % on an acid equivalent basis.

30. The composition of claim 1, wherein the concentration of the second acidic herbicide is from about 0.1 wt.% to about 35 wt. % on an acid equivalent basis.

31. The composition of claim 1, further comprising a surfactant component comprising at least one surfactant.

32. The composition of claim 31, wherein the at least one surfactant is selected from the group consisting of alkoxylated tertiary amines; alkoxylated tertiary etheramines; alkoxylated quaternary amines; alkoxylated quaternary etheramines; alkyl polysaccharides; amidoalkylamines; alkoxylated alcohols; alkoxylated etheramine oxides;
alkoxylated tertiary amine oxides; alkyl sulfates, alkyl ether sulfates and alkyl aryl ether sulfates;
alkyl sulfonates, alkyl ether sulfonates and alkyl aryl ether sulfonates; alkoxylated phosphate esters and diesters; and mixtures thereof.

33. The composition of claim 31, wherein the at least one surfactant comprises an alkoxylated quaternary amine.

34. The composition of claim 1, wherein the composition further comprises a monocarboxylic acid salt having the formula R¹—C(O)OM, wherein R¹ is substituted or unsubstituted C₁-C₂₀ alkyl, substituted or unsubstituted C₂-C₂₀ alkenyl, substituted or unsubstituted aryl, and substituted or unsubstituted arylalkyl and M is an agriculturally acceptable cation.

35. A method of controlling plant growth in a growing area comprising applying an application mixture comprising a herbicidal composition, or dilution thereof, to foliage of the plant;
wherein the herbicidal composition comprises:
a first acidic herbicide comprising a first acidic herbicide anion;
a second acidic herbicide comprising a second herbicide anion, wherein the first acidic herbicide and second acidic herbicide are not the same herbicide; and
a salt-forming cation of a diamine of Formula I: 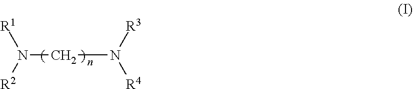
wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6.

36. The method of claim 35, wherein the growing area is in and/or adjacent to a field of crop plants.

37. A process for preparing an aqueous herbicidal composition, the process comprising:
mixing a first acidic herbicide comprising a first acidic herbicide anion, a second acidic herbicide comprising a second herbicide anion, water, and a diamine of Formula I: 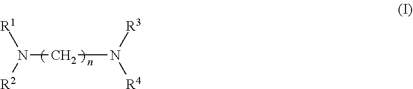
wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6 to form the composition.

38. The process of claim 37, wherein the molar ratio of total acidic herbicide to the diamine of Formula I is about 0.5:1 or greater.

39. The process of claim 37, wherein the molar ratio of total acidic herbicide to the diamine of Formula I is from about 0.5:1 to about 2:1.

40. A process for preparing an aqueous herbicidal composition, the process comprising:
mixing a first acidic herbicide comprising a first acidic herbicide anion, water, and a first amount of diamine of Formula I: 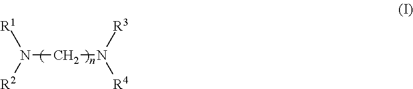
wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6 to form a first acidic herbicide salt solution;
mixing a second herbicide comprising a second acidic herbicide anion, water, and a second amount diamine of Formula Ito form a second acidic herbicide salt solution; and
mixing the first acidic herbicide salt solution and second acidic herbicide salt solution to form the composition.

41. The process of claim 40, wherein the molar ratio of total acidic herbicide to the total amount of diamine of Formula I is about 0.5:1 or greater.

42. The process of claim 40, wherein the molar ratio of total acidic herbicide to the total amount of diamine of Formula I is from about 0.5:1 to about 2:1.

43. A process for preparing an aqueous herbicidal composition, the process comprising:
mixing a first acidic herbicide salt solution comprising a first acidic herbicide anion and a cation of a diamine of Formula I: 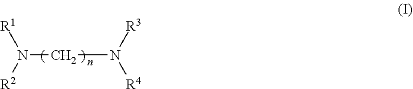
wherein R¹ is hydrogen or C₁-C₆ alkyl; R² is hydrogen or C₁-C₆ alkyl; R³ is hydrogen or C₁-C₆ alkyl; R⁴ is hydrogen or C₁-C₆ alkyl; and n is an integer from 1 to 6 with a second herbicide comprising a second acidic herbicide anion to form the composition.

44. The process of claim 43, wherein the molar ratio of total acidic herbicide to the diamine of Formula I is about 0.5:1 or greater.

45. The process of claim 43, wherein the molar ratio of total acidic herbicide to the diamine of Formula I is from about 0.5:1 to about 2:1.
